(19) United States
(12) Patent Application Publication
(10) Pub. No.: US 2006/0108003 A1
(43) Pub. Date: May 25, 2006

(54) Fluid flow and leak detection system

(76) Inventors: Steven K. Bradford, Edmond, OK (US); Andrew Jeffrey Kelly, Arlington, TX (US)

Correspondence Address: Lynn E. Barber, Post Office Box 16528, Fort Worth, TX, 76162, US

(21) Appl. No.: 10/989,058

(22) Filed: Nov. 15, 2004

(51) Int. Cl. G05D 7/06; G01M 3/28; G01N 25/72

(52) U.S. Cl. 137/487.5; 73/198; 73/204.11; 73/204.21; 73/204.25; 374/4; 73/40.5 R

(57) ABSTRACT

A fluid leakage monitoring method and system comprising an electronic control, a sensor to monitor fluid inflow to a point of use, a sensor to monitor fluid outflow from a point of use, and a shut off valve. Uneven and asymmetrical fluid usage is monitored by a point of use station and the system is shut down when levels indicate abnormalities between the flows.

### BACKGROUND OF THE INVENTION

1. Field of the Invention

This invention relates to the field of flow and leak detection of fluids flowing through a tube to a variable or steady point of use and the discharge associated with that usage.

2. Description of the Related Art

U.S. Pat. No. 5,568,825 is an excellent example of a leak detector for fluid flow to and from a building. In the body of the description of the patent the calls for 4 critical components of any absolute leak detector, which are 1) the inflow sensor, 2) the outflow sensor, 3) the shutoff valve, and 4) the control system. This system addresses fluid inflow with a sensitive valve that consists of a bypass and check valve that is able to detect very small flows. The outflow or backflow sensor accuracy is not required and tends to lend itself to monitoring fluid backup rather than fluid flow. This patent further describes the monitoring of leaks as only during unwatched low to no flow days. The control will shut the monitoring off during these periods.

For a good system to work with the confines of a home, business or industrial setting, it must be inexpensive, easy to maintain, and monitor both inflow and effluent flows of a liquid. U.S. Pat. No. 5,568,825 creates a special flow valve that measures inflow quite accurately but fails to bring outflow accuracy into the control loop. Relying on a electrical timer to allow a point of use a set amount of time before shutting off the main valve.

U.S. Pat. No. 5,062,442 concentrates on the inflow sensor for accuracy while minimizing the outflow sensors. U.S. Pat. No. 5,086,806 concentrates on detecting flow and shutting down after a large breakage has occurred.

U.S. Pat. No. 5,637,789 uses a very sensitive method of accurately detecting fluid flow at a minuscule level. It uses a check valve with a bypass on the input flow of the fluid but relies on inaccurate backflow monitors to complete the loop.

### SUMMARY OF THE INVENTION

The invention herein is a fluid leakage monitoring method and system comprising an electronic control, a sensor to monitor fluid inflow to a point of use, a sensor to monitor fluid outflow from a point of use, and a shut off valve. The invention monitors uneven and asymmetrical fluid usage by a point of use station and shuts down the system when levels indicate abnormalities between the flows.

Other objects and features of the inventions will be more fully apparent from the following disclosure and appended claims.

### BRIEF DESCRIPTION OF THE DRAWINGS

FIG. 1 is a cross section of an inflow sensor used in the invention herein.

FIG. 2 is a control schematic of the invention herein.

FIG. 3 is a schematic of a typical point of use of the invention herein.

FIG. 4 is a schematic diagram of an alternate embodiment of the invention.

FIG. 5 is a flow chart utilize by computer circuitry of the invention.

### DETAILED DESCRIPTION OF THE INVENTION AND PREFERRED EMBODIMENTS THEREOF

The invention herein is a fluid leakage monitoring method and system comprising an electronic control, a sensor to monitor fluid inflow to a point of use, a sensor to monitor fluid outflow from a point of use, and a shut off valve. The invention monitors uneven and asymmetrical fluid usage by a point of use station and shuts down the system when levels indicate abnormalities between the flows. It should be rioted that due to multiple identical components in the invention, the same identifying numbers are used for each identical component, rather than separately numbering each component with a different number.

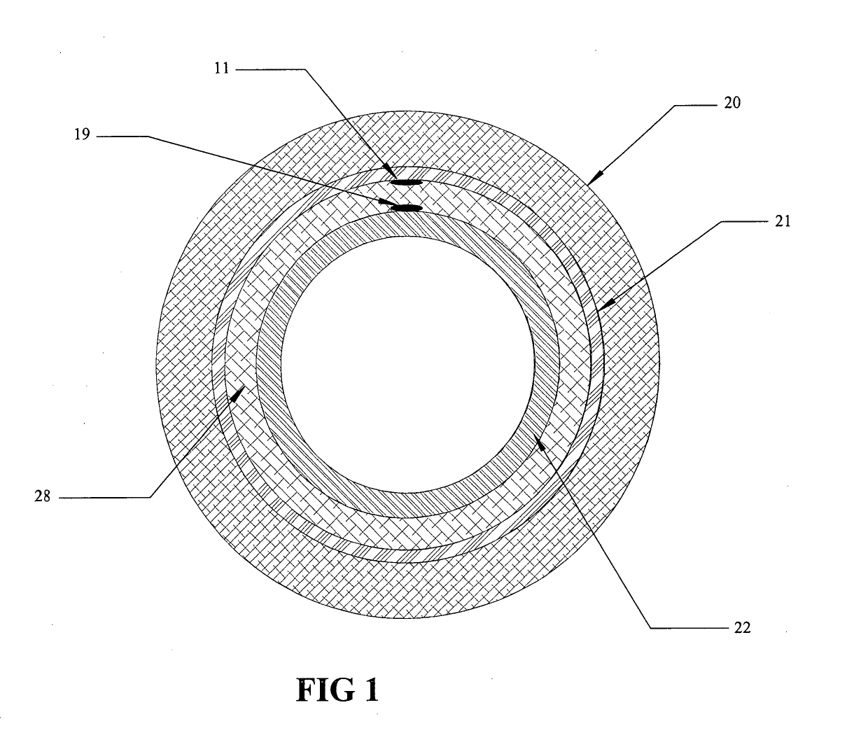

FIG. 1 is a cross section of the typical transducer utilized in the invention. It consists of thermistor 11, thermistor 19, insulation 20, insulation 28, tube 22 and electrical heater 21. Electrical heater 21 develops heat by resistance to electrical current. Heat dissipates from electrical heater 21 inward and outward of the layer that contains electrical heater 21. Insulation 20 reduces heat losses to the ambient air or other medium. Thermistor 11 monitors the temperature of the electrical heater 21 and is part of the feedback loop of the control. Insulation 28 is a thin layer of insulation designed to provide a temperature difference between temperatures measured at thermistor 19 and thermistor 11. To reduce error, insulation 28 has very little thermal capacitance reducing the time lag of the control. Fluid flows within the central interior of tube 22. Thermistor 19 is mounted directly to tube 22. It is important that the material of tube 22 have a high thermal conductance while minimizing the heat capacitance.

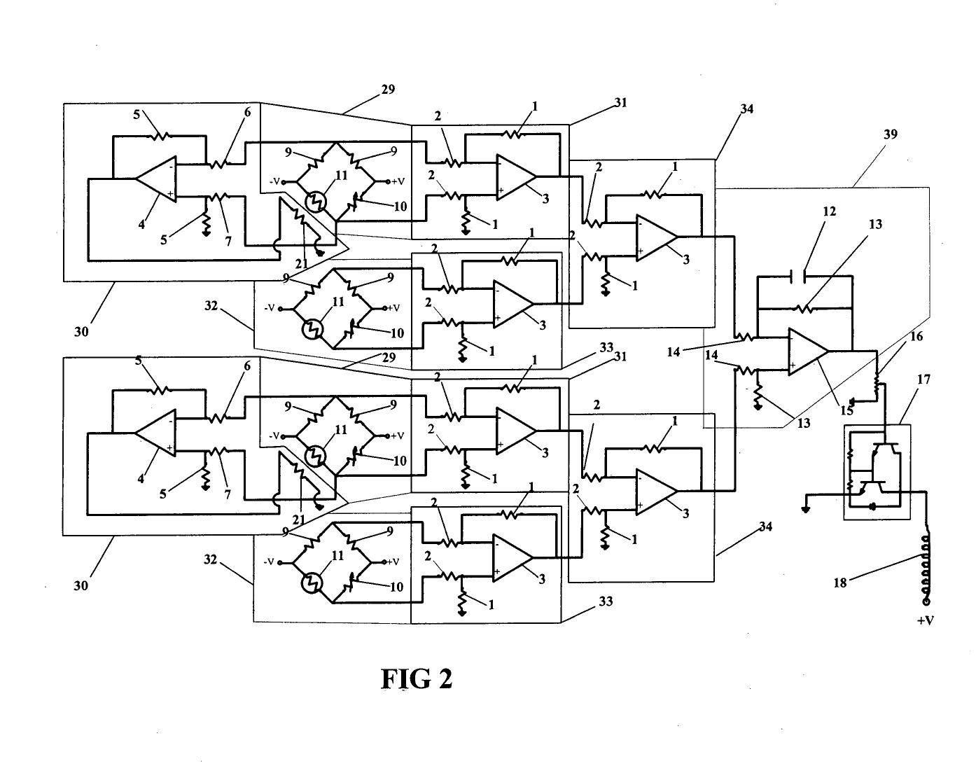

Feedback thermistor 19 is part of a Wheatstone bridge circuit 29 that feeds into the main control as shown in FIG. 2. Bridge circuit 29 contains two legs as shown in the figure. One leg contains a resistor 9 in series with thermistor 11 and the other leg consists of another resistor 9 and adjustable resistor 10. Thermistor 11 reduces resistance as the temperature of the electrical heater 21 raises. Adjustable resistor 10 is adjusted to maintain the temperature of electrical heater 21 at a set point.

The voltage difference between the two legs of bridge circuit 29 is the input to the temperature control circuit (for feedback temperature control) 30 by which heater 21 temperature is controlled. The temperature control circuit 30 contains operational amplifier (op amp) 4, resistor 5, resistor 7 and resistor 6. Op amp 4 is high voltage and high amperage capable of producing a large enough current for heater 21. To change the gain of temperature control circuit 30, feedback resistor 5 resistance is increased to provide faster response time of the inflow sensor 23. The voltage difference between the two legs of bridge circuit 29 also drives the differential circuit 31. The output voltage of circuit 31 is the base voltage of inflow sensor 23.

Bridge 32 utilizes thermistor 19 to measure the temperature at tube 22. This temperature is converted into a voltage difference by bridge 32. Differential circuit 33 produces an amplified voltage from bridge 32. Circuit 33 and differential circuit 31 use a standard op amp 3 to amplify the voltage. Voltage gain is obtained by increasing the resistance of resistors 1 relative to resistor 2.

The output voltages of circuit 31 and circuit 33 are inputs to the circuit 34. These voltages represent the temperatures at points defined by thermistors 11 and 19. Differential circuit 34 subtracts the voltage from circuit 33 from circuit 31 and amplifies the signal by feedback resistor 1. The output of circuit 34 is directly related to the heat flow from heater 21 to the fluid flow in tube 22. The larger the voltage output of circuit 34 the faster the fluid is the fluid flow in tube 22.

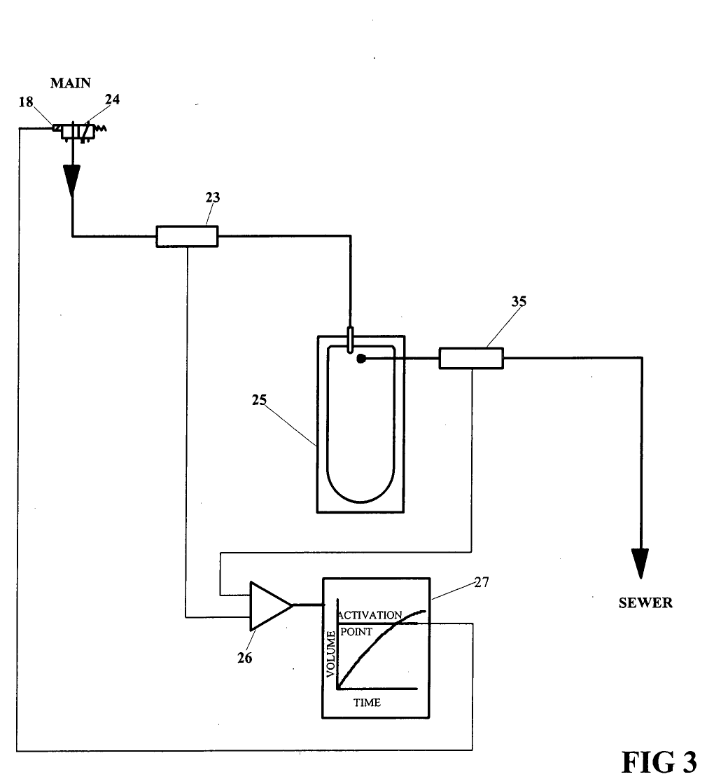

Circuits 29-34 and inflow sensor 23 are for the measurement of fluid flow to a point of use 25 as illustrated in FIG. 3. Outflow transducer (outflow sensor) 35 measures fluid flow from the point of use 25. The fluid flow is measured with control circuits by an identical set to circuits 29-34 illustrated in FIG. 2. Comparing the output flow to the input flow in control 26 produces a voltage 27 that is used to activate main valve 24.

The voltage difference between inflow sensor 23 and transducer 35 represents the water flow gain or loss. FIG. 2 illustrates the differential voltage at op amp 15. Placing capacitor 12 parallel to resistor 13 in this circuit now integrates the signal. Resistor 14 and resistor 13 develop the time constant necessary to produce an integrated signal with the chosen capacitor 12. This is shown in the sub-circuit 39 of FIG. 2. The voltage out of op amp 15 represents total gallons that are gained or lost. A variable resistor 16 adjusts the output voltage. This adjustment sets the sensitivity to fluid loss. If voltage is large enough to trigger the transistor 17, the engaging voltage will activate the coil 18 on the main valve 24 and the fluid will be shut off (FIG. 3).

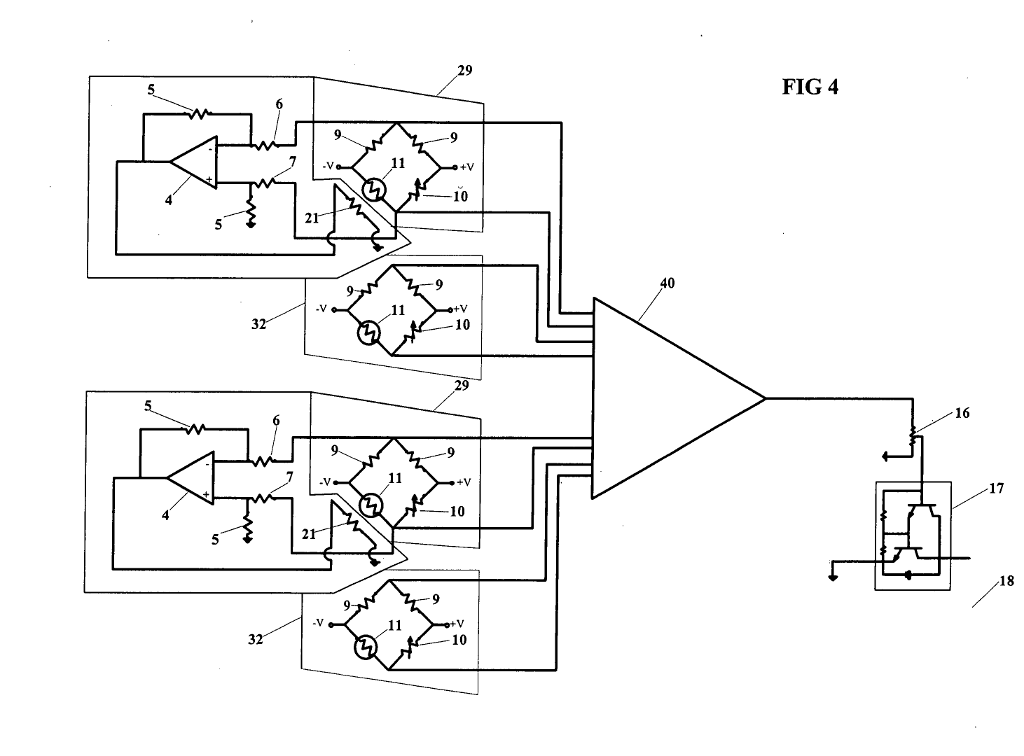

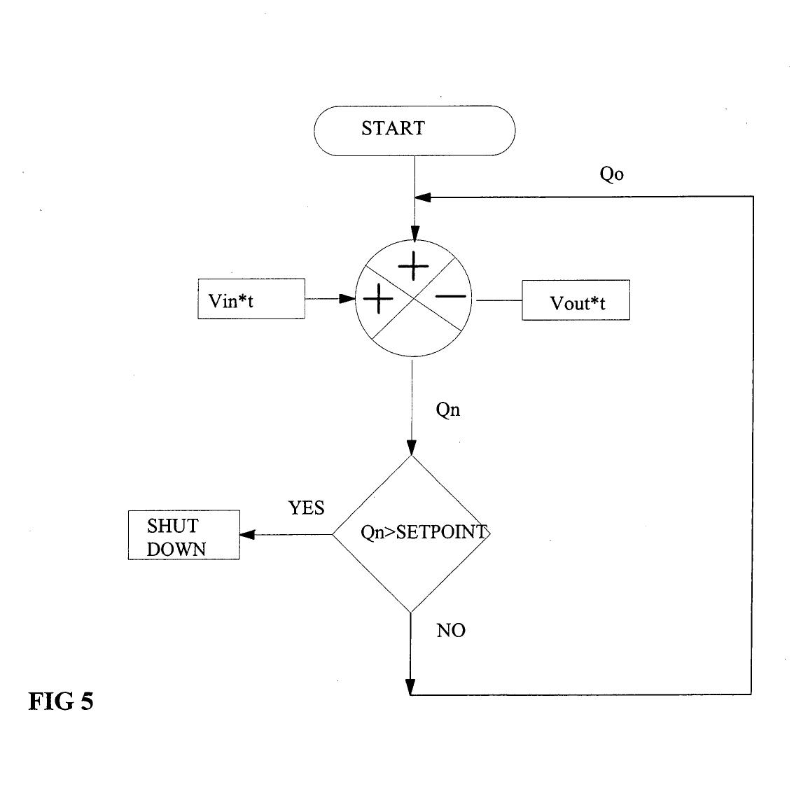

FIG. 4 illustrates a variation of the device but uses a computer circuitry 40 to replace sub-circuits 31, 34, 33 and 39. The computer circuitry 40 simulates the capacitor-resistor configuration of sub-circuit 39 and utilizes the flow chart of FIG. 5, where:

V1˜voltage from inflow transducer 23

V2˜voltage from outflow transducer 35

t˜small discrete time step

Qn˜represents volume accumulated at time T

Setpoint˜volume of fluid set in computer to activate overflow situation

Qo˜represents volume accumulate at time T−t

V1*t and V2*t therefore are the voltage from the inflow transducer times the time and voltage from the outflow transducer times the time, respectively. The + and − symbols in the circle in FIG. 5 represent a summing function that may be expressed as Qₙ=Qo+((V1*t)−(V2*t)).

Using the embodiment of the invention having the computer 40 makes it easier to change the characteristics and allow more portability of the invention

Another variation in the invention that may be used to affect the accuracy of the invention is the use of multiple thermistors 11 equally stationed around the transducer 35 or point of use 25. This would increase the sensitivity to extremely small flows.

### EXAMPLES OF COMPONENTS OF THE INVENTION

While there are many different components known in the art that may be used for the parts of the invention, following are particular components that have been used in this invention.

For operational amplifier 4, a preferred amplifier is model OPA548 (high-voltage, high-current op amp with excellent output swing) from Burr-Brown Products (Texas Instruments, Dallas, Tex.).

For circuits 31, 33 and 34, can be constructed using resistors 1 and 2 and op amp 3, or may be purchased as a single instrumentation amplifier, a preferred such amplifier being model INA128 (Burr-Brown Instruments).

For op amp 3 and 15, one may use part no. LM741 of National Semiconductor (Santa Clara, Calif.).

For the resistors 1, 2, 5-7, 9, one may use a 4.7 kilo-ohms, ¼ watt, 1% resistance tolerance of any manufacturer or supplier, such as Radio Shack.

For resistors 13, 14 one may use 10 MEG resistors as are known in the art.

For variable resistors 10, 16, one may use a variable multiturn resistor, such as Radio Shack part no. 271-343 (10 KΩ 0.75 W, 15-turn PC-mount trimmer).

For thermistor 11, one may use part no. 271-0110 of Radio Shack.

For transistor 17, one may use part no. Tip 120 of Radio Shack.

For electrical heater 21, one may use a THERMOFOIL™ heater/sensor made of Kapton polyimide film/acrylic, which has a size of 2×1 mm, and a temperature range of −200 to 150° C.

Operation

Leak detection is becoming more critical with the concern over mold development in residential housing as well as the economic considerations of repair of the damage inflicted upon the structure. Several methods exist in order to detect these destructive leaks. One way is to monitor the fluid flow into a building and maintain a control system that acts upon preset parameters. The common misconception is that leaks are detectable from the upstream. The variability at the point of use dictates a different approach.

A point of use can be described as the place where an operation or use occurs that utilizes a fluid. A tube delivers the fluid and a different tube carries away the effluent. The time spent at the point of use and the amount of liquid that can be temporarily stored at the point of use presents the difficulty of the solution.

This invention covers the points discussed earlier and expands them into a inexpensive and unique configuration. Consider a leak monitoring system. For accuracy it should possess 4 basic elements. They are:

1) Inflow measurement

2) Outflow measurement

3) Control

4) Shut off valve

Inflow measurement is done by a thermistor configuration mounted on the outside of the inflow tube. A majority of sensors that measure flow have some device that invades the flow tube. This device presents an obstruction and a pressure drop. The pressure drop may be insignificant, if the fluid is a pure liquid.

The thermistor configuration consists of multiple thermistors. Each thermistor is part of a Wheatstone bridge for greater sensitivity to minuscule variations of temperature change. This invention utilizes the variation of heat transfer as fluid flow varies; therefore, the ability to measure the variations in temperature is needed.

A small heat source is used to provide a temperature difference between the thermistors. A thermistor is used in a feed back loop of the control to maintain a constant temperature. Another thermistor is used to record the temperature of the tube either at the surface or with a small insulation between the thermistor and tube.

Heat transfer of a fluid varies as the velocity of the fluid. Resistance to heat flow reduces allowing the temperature on the wall of the tube surface to approach the temperature of the fluid in transit.

The heat source temperature is maintained at a constant temperature. When there is no flow of fluid in the tube the temperature difference that is sensed between the two thermistors is relatively small as compared when the flow is larger. The difference is predictable and repeatable; therefore, can be used to determine flow.

In this invention, this method of sensing flow is used both in the inflow and outflow measurements. This method of sensing does not need to penetrate or impede the flow making it ideal for liquids containing solids such as sewage.

Leakage is assessed in control by comparing the inflow sensor with the outflow sensor. The temperature difference, which represents the corresponding fluid flow, is compared and amplified in the control. When the difference occurs between the inflow and outflow a voltage is produced and can be utilized to shut off the main valve.

If a point of use is the system, such as a sink, a time delay is required. A resistor and capacitor is used in the control loop of the electronics. Connecting across the output op amp with a sufficient sized capacitor can be used to keep the control from activating the main valve. Fluid flows into the sink at a given rate. The sink has been stopped from flowing. Fluid does not flow out through the outflow sensor. Fluid flowing into the sink develops a voltage across the inflow sensor, which in turn is sensed by the control. The voltage is integrated across the output op-amp. The voltage out now represents the amount of fluid that has built up in the sink. The voltage used to trigger the main valve is adjusted electronically.

This method allows for flexibility and reliability for full time use.

What is claimed is:

1) A fluid flow and leak detection system, comprising:
a) an inflow temperature sensor to monitor fluid inflow in an inflow tube to a point of use;
b) an outflow temperature sensor to monitor fluid outflow in an outflow tube from the point of use; and
c) a feedback control for comparing temperature difference between the inflow temperature sensor and the outflow temperature sensor; and
wherein the temperature difference between the inflow temperature sensor and the outflow temperature sensor is used to determine flow of the fluid without interfering with flow of the fluid.

2) The fluid flow and leak detection system of claim 1, further comprising a shut-off valve which can be electronically activated when the determination of the flow of the fluid indicates uneven and asymmetric fluid flow, due to leakage of fluid.

3) The fluid flow and leak detection system of claim 2, wherein activation of the shut-off valve is delayed after determination of the uneven and asymmetric fluid flow.

4) The fluid flow and leak detection system of claim 3, wherein the shut-off valve delay is accomplished using a capacitor and resistor.

5) The fluid flow and leak detection system of claim 1, wherein the inflow temperature sensor comprises a configuration of thermistors mounted on the outside of the inflow tube.

6) The fluid flow and leak detection system of claim 1, wherein the outflow temperature sensor comprises a configuration of thermistors mounted on the outside of the outflow tube.

7) The fluid flow and leak detection system of claim 1, wherein the feedback control comprises a feedback thermistor and a feedback resistor.

8) The fluid flow and leak detection system of claim 1, wherein the inflow temperature sensor comprises a configuration of thermistors mounted on the outside of the inflow tube, the outflow temperature sensor comprises a configuration of thermistors mounted on the outside of the outflow tube, and the feedback control comprises a feedback thermistor and a feedback resistor.

9) The fluid flow and leak detection system of claim 2, wherein the inflow temperature sensor comprises a configuration of thermistors mounted on the outside of the inflow tube, the outflow temperature sensor comprises a configuration of thermistors mounted on the outside of the outflow tube, and the feedback control comprises a feedback thermistor and a feedback resistor.

10) The fluid flow and leak detection system of claim 1, wherein the fluid contains solids.

11) A method of measuring fluid flow and detecting leaks, comprising providing a fluid flow and leak detection system according to claim 1.

12) The method of measuring fluid flow and detecting leaks according to claim 11, further comprising providing a shut-off valve which can be electronically activated when the determination of the flow of the fluid indicates uneven and asymmetric fluid flow, due to leakage of fluid.

13) The method of measuring fluid flow and detecting leaks according to claim 12, further comprising delaying activation of the shut-off valve after determination of the uneven and asymmetric fluid flow.

14) The method of measuring fluid flow and detecting leaks according to claim 11, wherein the inflow temperature sensor of the provided fluid flow and leak detection system comprises a configuration of thermistors mounted on the outside of the inflow tube, the outflow temperature sensor of the provided fluid flow and leak detection system comprises a configuration of thermistors mounted on the outside of the outflow tube, and the feedback control of the provided fluid flow and leak detection system comprises a feedback thermistor and a feedback resistor.
